(19) United States
(12) Patent Application Publication
(10) Pub. No.: US 2010/0109909 A1
(43) Pub. Date: May 6, 2010

(54) APPARATUS AND METHOD FOR INFORMING OF CHILDREN-PROTECTION

(76) Inventors: Dongwan RYOO, Daejeon-city (KR); Changseok BAE, Daejeon-city (KR); Jintae KIM, Daejeon-city (KR); Kwangroh PARK, Daejeon-city (KR); Jigeun LEE, Jeonbuk (KR); Younggiu JUNG, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/574,850

(22) Filed: Oct. 7, 2009

(30) Foreign Application Priority Data
Nov. 6, 2008 (KR) 10-2008-0109683

(51) Int. Cl. G08G 1/09

(52) U.S. Cl. 340/905

(57) ABSTRACT

There are disclosed an apparatus and a method for informing of children-protection that provides a position of a child and surrounding environment information to parents of the child. The apparatus for informing of children-protection includes: a communication unit that receives user information transmitted from a user terminal; an informing information storing unit that stores terminal information corresponding to each user information; and an informing control unit that detects the terminal information corresponding to the user information received by the communication unit from the informing information storing unit and transmits position information of the user terminal to a terminal corresponding to the terminal information detected through the communication unit.

### RELATED APPLICATIONS

The present application claims priority to Korean Patent Application Serial Number 10-2008-0109683, filed on Nov. 6, 2008, the entirety of which is hereby incorporated by reference.

### BACKGROUND OF THE INVENTION

1. Field of the Invention

The present invention relates to an apparatus and a method for informing of children-protection, and more particularly, to an apparatus and a method for informing of children-protection for minimizing occurrence of child accidents in a school zone.

2. Description of the Related Art

Recently, child accident such as kidnapping, occurrence of a lost child, etc. are becoming more common in a school zone. As a result, a child protector deals with the occurrence of the child accident by grasping a movement route, a current position, etc. of the child.

In general, a mobile communication system and a global positioning system (hereinafter, referred to as ‘GPS’) are used as a method for grasping the position of the child. The method for grasping the position of a mobile communication terminal using the mobile communication system includes a method for grasping a cell-unit position based on a base station that communicates with the mobile communication terminal and a position estimated by an approximate distance from adjacent base stations that can receive a signal of the mobile communication terminal. The GPS is a system configured to a three-dimensional position composed of latitude, longitude, and altitude and time deviation by using a satellite and is configured to measure a current position, time information, etc. by processing a signal which a GPS receiver mounted in a moving body receives from the satellite.

Further, the known position measuring method is divided into an angle of arrival (AOA) method for measuring an arrival angle of a signal, a time of arrival (TOA) method for measuring a radio transmission time, and a hybrid method acquired by mixing the methods depending on a measurement method.

However, the known position measuring system using the mobile communication system and the GPS provides too much information to the protector by providing position information on the child to the protector when the position of the child has changed.

Further, since the known position measuring system using the mobile communication system and the GPS provides only the position information of the child, the known position measuring system cannot grasp a current status of the child, thereby causing the protector's uneasiness.

In addition, an additional service fee is charged for the known position measuring system using the mobile communication system and the GPS, thus imposing an economical burden on the protector.

Moreover, in the case of the known position measuring system using the mobile communication system and the GPS, since the child should always possess an additional terminal (for example, a cellular phone, a GPS device, etc.), it is difficult to grasp the position of the child if the child loses the terminal.

### SUMMARY OF THE INVENTION

The present invention is contrived to solve the above-mentioned known problems. A first object of the present invention is to provide an apparatus and a method for informing of children-protection that provides a position of a child and surrounding environment information to parents of the child.

A second object of the present invention is to provide an apparatus and a method for informing of children-protection that informs a driver of a vehicle that enters a school zone of the school zone by wireless.

A third object of the present invention is to provide an apparatus and a method for informing of children-protection that uses green energy such as self-generated solar energy as a power supply.

In order to achieve the above-mentioned objects, an apparatus for informing of children-protection, which is installed in a school zone, according to an aspect of the present invention includes: a communication unit that receives user information transmitted from a user terminal; an informing information storing unit that stores terminal information corresponding to each user information; and an informing control unit that detects the terminal information corresponding to the user information received by the communication unit from the informing information storing unit and transmits position information of the user terminal to a terminal corresponding to the terminal information detected through the communication unit.

The apparatus for informing of children-protection further includes a self-generation unit that is self-generated to supply power to the communication unit, the informing information storing unit, and the informing control unit, wherein the self-generation unit includes a solar energy acquiring unit and a charge unit, and a battery.

The informing information storing unit stores position information of the school zone and the informing control unit transmits the position information stored in the informing information storing unit as the position information of the user terminal.

The communication unit receives environment information including at least one of an image and a sound from the user terminal in addition to the user information.

The informing control unit transmits the environment information received by the communication unit to the user terminal through the communication unit.

The informing control unit periodically transmits at least one of the position information of the user terminal and environment information received from the user terminal.

The communication unit exchanges information with the user terminal through a wireless LAN SSID.

The terminal information stored in the informing information storing unit is information of a protector terminal corresponding to the user information.

The communication unit transmits entrance information for informing a vehicle which enters a school zone of entering the school zone.

In order to achieve the above-mentioned objects, a method for informing of children-protection using an apparatus for informing of children-protection, which is installed in a school zone, according to another aspect of the present invention includes: receiving, by a communication unit, user information transmitted from a user terminal; detecting, by an informing control unit, terminal information corresponding to the user information received in receiving the user information from an informing information storing unit; and transmitting, by the informing control unit, position information of the user terminal to a terminal corresponding to terminal information detected in detecting the terminal information.

The method for informing of children-protection further includes providing self-generated power supply, by a self-generation unit, to the communication unit, the informing information storing unit, and the informing control unit.

In transmitting the position information of the user terminal, the informing control unit transmits position information of the school zone, which is stored in the informing information storing unit as the position information of the user terminal.

In receiving the user information, the communication unit receives environment information including at least one of a user image and a user sound from the user terminal in addition to the user information.

In transmitting the position information of the user terminal, the informing control unit transmits the environment information received in receiving the user information to the user terminal through the communication unit.

In transmitting the position information of the user terminal, the informing control unit periodically transmits at least one of the position information of the user terminal and the environment information received from the user terminal.

In transmitting the position information of the user terminal, the communication unit exchanges information with the user terminal through a wireless LAN SSID.

In transmitting the position information of the user terminal, the communication unit transmits entrance information for informing a vehicle which enters the school zone of entering the school zone.

According to an embodiment of the present invention, an apparatus and a method for informing of children-protection can minimize the amount of unnecessary information provided to a protector by providing user's position information to the protector when a user enters a school zone.

Further, the apparatus and method for informing of children-protection can minimize uneasiness of the protector by providing the user's position information and user's surrounding environment information, and providing a user's status to the protector, and grasp an occurrence cause of an accident when the accident occurs and cope with the accident.

In addition, in the case of the apparatus and the method for informing of children-protection, by providing user's position information and environment information using a service set identifier (SSID) technique, since an additional service fee is not charged when the user possesses only a terminal which can be connected to the Internet, it is possible to minimize an economical burden of the protector.

In the case of the apparatus and the method for informing of children-protection, by providing the user's positional information and environment information using the SSID technique, it is possible to prevent an outflow of personal information by transmitting information to only a protector terminal connected through an additional network.

In the case of the apparatus for informing of children-protection, power is supplied through self generation using green energy such as solar energy, etc., such that supply of external power is unnecessary and as a result, management is unnecessary, thereby minimizing a maintenance cost of a system.

Besides, in the case of the apparatus and the method for informing of children-protection, by using a user terminal which is miniaturized and mounted on user's bag, clothes, etc., a problem in losing the terminal is solved and the protector grasps the current position of the user, thereby preventing the accident from occurring.

Moreover, in the case of the apparatus and the method for informing of children-protection, a driver who receives an alarm message through vision, auditory, and haptic signals can decelerate a vehicle by informing the driver of the vehicle which enters a school zone of the school zone, thereby preventing a traffic accident from occurring in the school zone.

### BRIEF DESCRIPTION OF THE DRAWINGS

FIG. 1 is a diagram for illustrating an apparatus for informing of children-protection according to an embodiment of the present invention;

FIG. 2 is a block diagram for illustrating a configuration of a user terminal of FIG. 1;

FIG. 3 is a block diagram for illustrating a configuration of a vehicle terminal of FIG. 1;

FIGS. 4 to 6 are diagrams for illustrating a configuration of an apparatus for informing of children-protection according to an embodiment of the present invention;

FIG. 7 is a flowchart for illustrating a method for informing of user's position information in a method for informing of children-protection according to an embodiment of the present invention; and

FIG. 8 is a flowchart for illustrating a method for informing of school zone entering information in a method for informing of children-protection according to an embodiment of the present invention.

### DETAILED DESCRIPTION OF THE PREFERRED EMBODIMENTS

Hereinafter, most preferred embodiments of the present invention will be described in detail with reference to the accompanying drawings so that those skilled in the art may easily implement the spirit of the present invention. First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention.

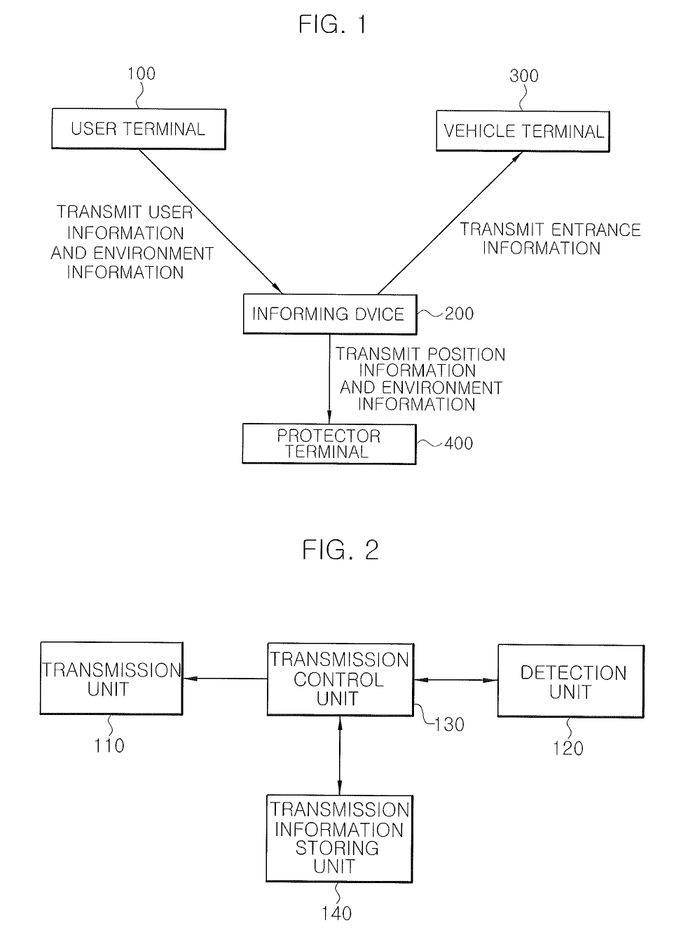

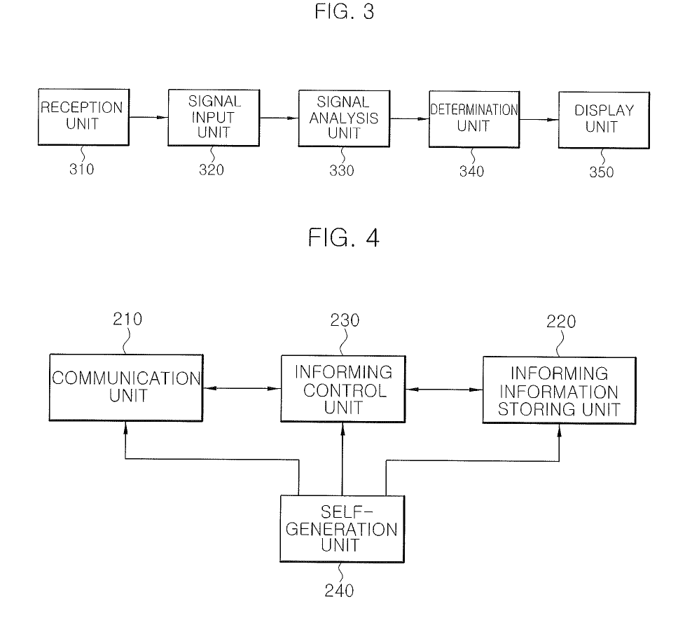

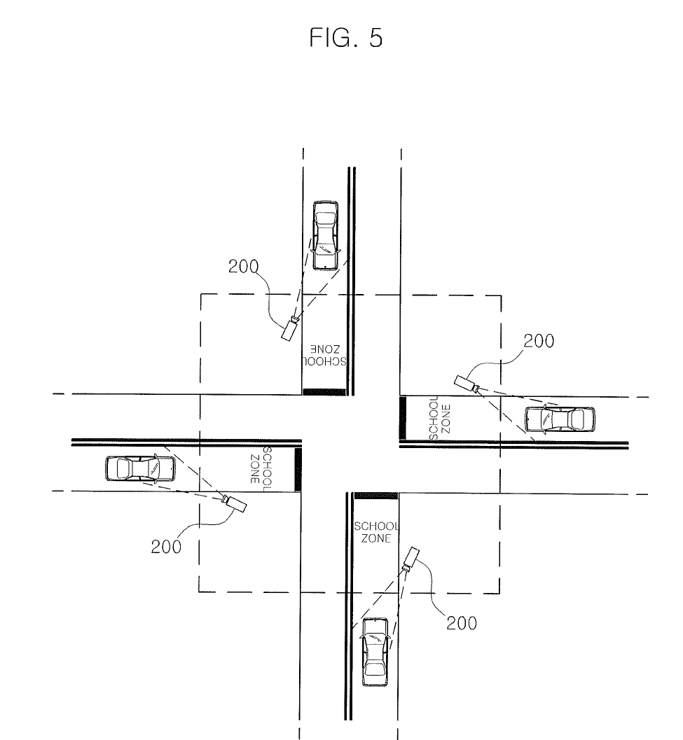

FIG. 1 is a diagram for illustrating an apparatus for informing of children-protection according to an embodiment of the present invention. FIG. 2 is a block diagram for illustrating a configuration of a user terminal of FIG. 1 and FIG. 3 is a block diagram for illustrating a configuration of a vehicle terminal of FIG. 1.

As shown in FIG. 1, the children-protection informing apparatus 200 is connected to one or more user terminal 100, one or more vehicle terminal 300, and one or more protector terminal 400.

The user terminal 100 transmits user information for differentiating users. That is, the user terminal 100 transmits environment information including user information including a unique ID assigned for each user. At this time, the user terminal 100 configures and transmits the user information as digital data or transmits a unique frequency previously set for each user terminal 100 instead of the user information. Herein, unlike a known mobile communication terminal and a known GPS device, since the user terminal 100 transmits the previously set unique frequency, a function of the user terminal 100 can be implemented by a simple configuration. Therefore, the user terminal 100 can be miniaturized and incorporated in goods such as user's clothes, bag, etc. Like this, the children-protection informing apparatus 200 and the children-protection informing method solves a problem in losing the terminal by using the user terminal 100 which is miniaturized and mounted on the user's bag, clothes, etc. to allow a protector to grasp a current position of a user, thereby preventing an accident from occurring.

The user terminal 100 transmits the environment information to be transmitted to a protector terminal 400. That is, the user terminal 100 records and stores a user's surrounding environment, and records and stores sounds around the user. The user terminal 100 transmits stored user images and user sounds as the environment information. Herein, the user terminal 100 records the user's surrounding environment by using a camcorder or a camera and records the sounds around the user by using a sound recorder.

As shown in FIG. 2, the user terminal 100 includes a transmission unit 110 that transmits the user information and the environment information, a detection unit 120 that records the user images which are images for the user's surrounding environment and records the user sounds which are sounds generated from the user's surrounding environment, a transmission information storing unit 140 that stores the user information including the unique ID assigned for each user and stores the user images and the user sounds detected by the detection unit 120, and a transmission control unit 130 that controls to detect and transmit the user information and the environment information stored in the transmission information storing unit 140. Herein, the transmission unit 110, which is constituted by an antenna and a frequency oscillator, transmits the unique frequency previously set for each terminal instead of the user information and may substitute for transmission of the user information. The detection unit 120 includes image recording devices such as the camcorder, the camera, etc. which can record the user images and the sound recorder, etc. which can record the user sounds.

The children-protection informing apparatus 200, which is installed in a building, a telephone pole, a road, etc. that are positioned in a school zone, receives the user information and the environment information from the user terminal 100. The children-protection informing apparatus 200 transmits the position information and the environment information of the user terminal 100 to the corresponding protector terminal 400 by using a wireless LAN SSID on the basis of the received user information.

The children-protection informing apparatus 200 is driven by a power supply that is self-generated by using green energy such as solar energy, etc. and transmits entrance information for informing a vehicle which enters the school zone of entering the school zone. Herein, the children-protector informing apparatus 200 will be described in detail with reference to the accompanying drawings.

The vehicle terminal 300, which is installed in the vehicle, informs a driver of the vehicle of entering the school zone on the basis of the entrance information received from the children-protection informing apparatus 200. That is, the vehicle terminal 300 informs the driver of entering the school zone by generating an alarm signal with a sound, an image, vibration, etc. at the time of receiving the entrance information from the children-protection informing apparatus 200. Herein, the vehicle terminal 300 may be installed in the vehicle as an additional terminal or may be installed with being included in additional devices mounted on the vehicle, such as a car audio, a navigation, etc.

As shown in FIG. 3, the vehicle terminal 300 includes a reception unit 310 that receives a wireless signal, a signal input unit 320 that converts the wireless signal received through the reception unit 310 into a digital signal, a signal analysis unit 330 that analyzes the size or frequency, or information of the wireless signal converted by the signal input unit 320, a determination unit 340 that determines whether or not to enter the school zone on the basis of the wireless signal analyzed by the signal analysis unit 330, and a display unit 350 that informs the user of the school zone by using the sounds or images when the determination unit 340 determines that the user enters the school zone.

The protector terminal 400 displays the position information of the user terminal 100, which is received from the children-protection informing apparatus 200 to inform a protector of the user of the position of the user. At this time, the protector terminal 400 may receive and display the use images and sounds from the children-protection informing apparatus 200 in addition to the position information of the user terminal 100. Herein, the protector terminal 400 can use all devices that can receive data through wired/wireless networks (i.e., an SSID communication network) and output the data as an image and/or a sound, such as a cellular phone, a PDA, a notebook, a UMPC, a desktop, etc.

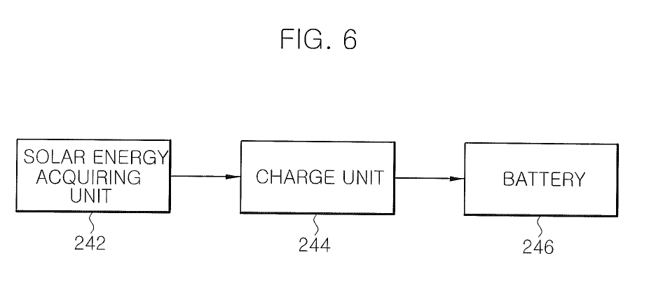

FIGS. 4 to 6 are diagrams for illustrating a configuration of an apparatus for informing of children-protection of FIG. 1 according to an embodiment of the present invention.

As shown in FIG. 4, the children-protection informing apparatus 200 includes a communication unit 210, an informing information storing unit 220, an informing control unit 230, and a self-generation unit 240.

The communication unit 210 receives the user information and the environment information that are transmitted from the user terminal 100. That communication unit 210 receives the user information including the unique user ID assigned for each user and the environment information including any one of the user image and the use sound from the user terminal 100.

The communication unit 210 transmits the position information of the user terminal 100 and the environment information to the protector terminal 400. That is, the communication unit 210 transmits position information stored in the informing information storing unit 220 as the position information of the user terminal 100 to the protector terminal 400 in addition to the environment information received from the user terminal 100. Herein, the communication unit 210 exchanges information with the protector terminal 400 through the wireless LAN SSID. That is, the communication unit 210 is connected to the Internet through the wireless LAN SSID to transmit the position information of the user terminal 100 and the environment information to the protector terminal 400. As such, in the case of the children-protection informing apparatus 200 and the children-protection informing method, by providing user's position information and environment information using a service set identifier (SSID) technique, since an additional service fee is not charged when the user possesses only a terminal which can be connected to the Internet, it is possible to minimize an economical burden of the protector and by transmitting the information to only the protector terminal 400 connected through an additional network, it is possible to prevent an outflow of personal information.

The communication unit 210 additionally transmits entrance information for informing the vehicle which enters the school zone of entering the school zone. That is, the communication unit 210 transmits a predetermined frequency in a direction in which the vehicle enters the school zone to inform the vehicle which enters the school zone of entering the school zone as shown in FIG. 5. Herein, the communication unit 210 may convert the entrance information including a regulation speed, the position information, etc. into digital data and transmit the digital data.

The informing information storing unit 220 stores protector terminal information corresponding to each user information. That is, the informing information storing unit 220 stores the protector terminal information for each user ID which is included in each user information. Herein, the informing information storing unit 220 stores the protector terminal information including a telephone number, an IP, etc. depending on the type of the protector terminal 400.

The informing information storing unit 220 stores position information of the school zone. That is, the informing information storing unit 220 stores the position information of the school zone where the children-protection informing apparatus 200 is installed. Herein, the position information stored in the informing information storing unit 220 is used as the position information of the user terminal, which is transmitted to the protector terminal 400.

The informing control unit 230 detects the protector terminal information corresponding to the user information received by the communication unit 210 from the informing information storing unit 220. That is, the informing control unit 230 detects the protector terminal information corresponding to a user ID included in the user information received by the communication unit 210 from the informing information storing unit 220.

The informing control unit 230 controls the communication unit 210 to transmit the position information of the user terminal 100 to the protector terminal 400 corresponding to the protector terminal information detected through the communication unit 210. That is, the informing control unit 230 controls the communication unit 210 to transmit the position information of the user terminal 100 to the protector terminal 400 by using the telephone number, IP, etc. of the protector terminal 400, which are included in the pre-detected protector terminal information. Herein, the informing control unit 230 controls the communication unit 210 to transmit the position information of the school zone stored in the informing information storing unit 220 as the position information of the user terminal 100 to the protector terminal 400.

The informing control unit 230 controls the communication unit 210 to transmit the environment information received by the communication unit 210 to the protector terminal 400. That is, the informing control unit 230 controls the communication unit 210 to transmit the environment information including at least one of the user image and the user sound which are received by the communication unit 210 to the pre-detected protector terminal 400 in addition to the position information of the user terminal 100. Herein, the informing control unit 230 controls the communication unit 210 to transmit at least one of the position information of the user terminal 100 and the environment information only when the user terminal 100 enters the school zone or periodically at a predetermined time interval (i.e., 10 minutes, 30 minutes, etc.) set by the protector. As such, the children-protection informing apparatus 200 and the children-protection informing method can minimize uneasiness of the protector by providing the user's position information and user's surrounding environment information, and providing a user's status to the protector, and grasp an occurrence cause of an accident when the accident occurs and cope with the accident. Further, the children-protection informing apparatus 200 and the children-protection informing method can minimize the amount of unnecessary information provided to a protector by providing user's position information to the protector when a user enters a school zone.

The informing control unit 230 controls the communication unit 210 to additionally transmit the entrance information for informing the vehicle which enters the school zone of entering the school zone.

The self-generation unit 240 supplies the power generated through self-generation using the green energy to the communication unit 210, the informing information storing unit 220, and the informing control unit 230. Herein, in the case of using the solar energy, the self-generation unit 240 is constituted by solar cells and includes a solar energy acquiring unit 242 that acquires the solar energy generated from the sun and a charge unit 244 that converts the solar energy acquired by the solar energy acquiring unit 242 into electric energy and charges a battery 246 with the electric energy, as shown in FIG. 6. For example, in the self-generation unit 240, the solar energy acquiring unit 242, which is constituted by the solar cells, acquires the solar energy (i.e., light and heat) from the sun and the charge unit 244 converts the acquired solar energy (i.e., light and heat) into the electric energy and charges the battery 246 with the electric energy. The communication unit 210, the informing information storing unit 220, and the informing control unit 230 are driven by using the electric energy supplied from the battery 246 that stores the electric energy into which the solar energy is converted as the power. Herein, the self-generation unit 240 may be self-generated by using the green energy of various types in addition to the solar energy. As such, the apparatus 200 for informing of children-protection can minimize a maintenance cost of a system by supplying the power through the self-generation using the green energy such as the solar energy, etc.

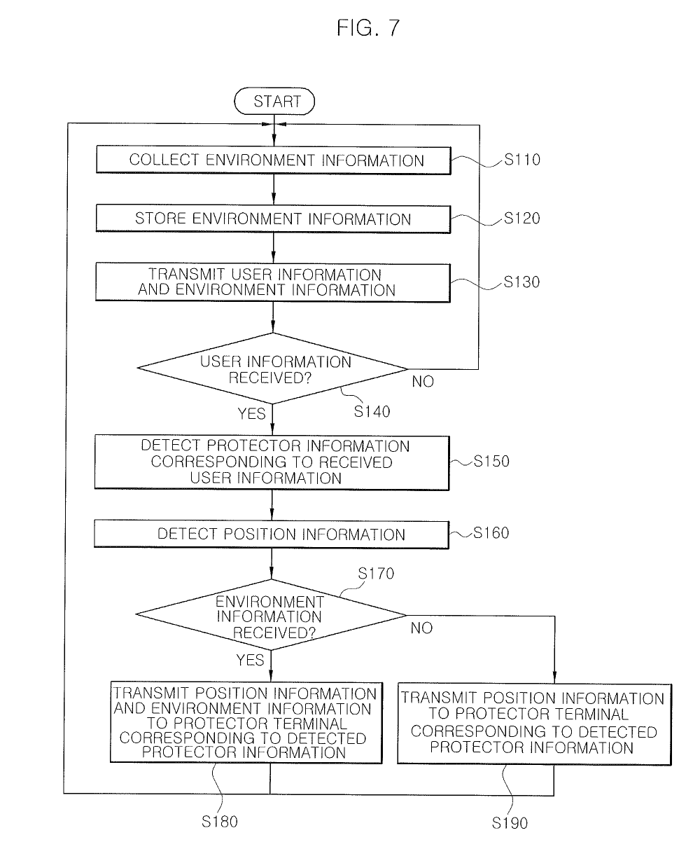

FIG. 7 is a flowchart for illustrating a method for informing of user's position information in a method for informing of children-protection according to an embodiment of the present invention.

First, a user terminal 100 records user images and records user sounds (S110). The user terminal 100 records images or photographs for a user's surrounding environment in a detection unit 120 that is constituted by a camcorder, a camera, etc. The user terminal 100 records sounds generated around a user in the detection unit 120 that is constituted by a sound recorder, etc.

The user terminal 100 stores the recorded user images and the recorded user sounds (S120). A transmission information storing unit 140 stores the user images and the user sounds from the detection unit 120 as environment information.

The user terminal 100 transmits user information and the stored environment information to the outside (S130). A transmission control unit 130 detects the user information and the environment information including the user images and the user sounds from the transmission information storing unit 140. Thereafter, the transmission control unit 130 transmits a signal including user information and environment information detected by a transmission unit 110.

While the user terminal 100 repetitively performs steps 5110 to 5130, a user who possesses the user terminal 100 enters a reception zone of a children-protection informing apparatus 200 and when the children-protection informing apparatus 200 receives the user information and the environment information (S140; YES), the children-protection informing apparatus 200 detects protector information corresponding to the received user information (S150). When the user information and the environment information transmitted from the user terminal 100 are received into a communication unit 210 of the children-protection informing apparatus 200, a user ID is detected from the received user information. An informing control unit 230 of the children-protection informing apparatus 200 detects protector information corresponding to a user ID detected from the protector information for each of a plurality of user IDs stored in an informing information storing unit 220.

Next, the children-protection informing apparatus 200 detects position information (S160). The informing control unit 230 detects position information of a school zone where the children-protection informing apparatus 200 is installed from the informing information storing unit 220.

When the environment information is received in addition to the user information (S170; YES), the children-protection informing apparatus 200 transmits both the detected position information and environment information to a protector terminal 400 corresponding to detected protector information (S180).

At this time, when the environment is not received and only the user information is received, the children-protection informing apparatus 200 transmits only the detected position information to the protector terminal 400 corresponding to the detected protector information (S190).

Herein, the informing control unit 230 transmits at least one of the position information of the user terminal 100 and the environment information only when the user terminal 100 enters the school zone. Of course, the informing control unit 230 may control the communication unit 210 to transmit at least one information periodically at a predetermined time interval (i.e., 10 minutes, 30 minutes, etc.) set by the protector.

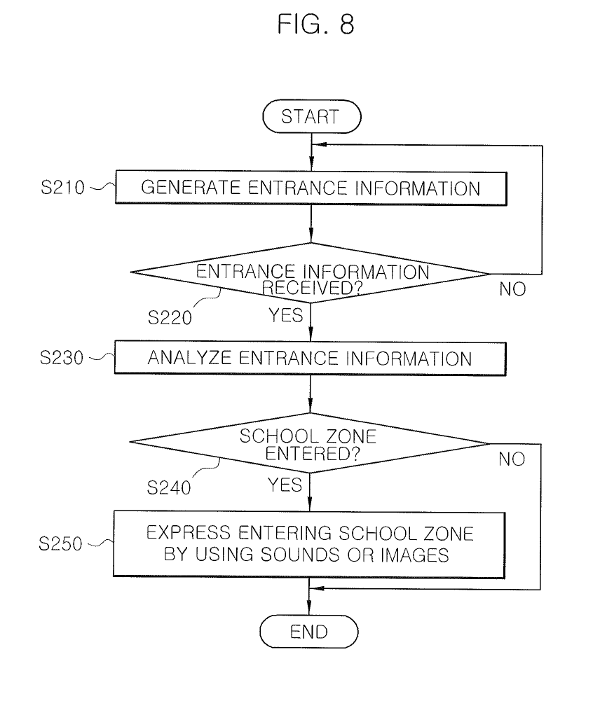

FIG. 8 is a flowchart for illustrating a method for informing of school zone entering information in a method for informing of children-protection according to an embodiment of the present invention.

The children-protection informing apparatus 200, which is installed in a building, a telephone pole, a road, etc. that are positioned in the school zone, transmits entrance information for informing a vehicle which enters the school zone of entering the school zone (S210).

As the driving vehicle receives the entrance information transmitted from the children-protection informing apparatus 200 while entering an entrance of the school zone (S220; YES), a vehicle terminal 300 analyzes the received entrance information to determine entering the school zone or not (S230).

When the vehicle terminal 300 determines entering the school zone (S240; YES), the vehicle terminal 300 expresses entering the school zone by using sounds or images and informs a driver of the vehicle of entering the school zone (S250).

Although preferred embodiments of the present invention have been described, it will be appreciated by those skilled in the art that various modifications and changes may be made without departing from the appended claims of the present invention.

What is claimed is:

1. An apparatus for informing of children-protection, which is installed in a school zone, comprising:
a communication unit that receives user information transmitted from a user terminal;
an informing information storing unit that stores terminal information corresponding to each user information; and
an informing control unit that detects the terminal information corresponding to the user information received by the communication unit from the informing information storing unit and transmits position information of the user terminal to a terminal corresponding to the terminal information detected through the communication unit.

2. The apparatus for informing of children-protection according to claim 1, further comprising:
a self-generation unit that is self-generated to supply power to the communication unit, the informing information storing unit, and the informing control unit, wherein the self-generation unit includes a solar energy acquiring unit and a charge unit, and a battery.

3. The apparatus for informing of children-protection according to claim 1, wherein the informing information storing unit stores position information of the school zone and the informing control unit transmits the position information stored in the informing information storing unit as the position information of the user terminal.

4. The apparatus for informing of children-protection according to claim 1, wherein the communication unit receives environment information including at least one of an image and a sound from the user terminal in addition to the user information.

5. The apparatus for informing of children-protection according to claim 4, wherein the informing control unit transmits the environment information received by the communication unit to the user terminal through the communication unit.

6. The apparatus for informing of children-protection according to claim 1, wherein the informing control unit periodically transmits at least one of the position information of the user terminal and environment information received from the user terminal.

7. The apparatus for informing of children-protection according to claim 1, wherein the communication unit exchanges information with the user terminal through a wireless LAN SSID.

8. The apparatus for informing of children-protection according to claim 1, wherein the terminal information stored in the informing information storing unit is information of a protector terminal corresponding to the user information.

9. The apparatus for informing of children-protection according to claim 1, wherein the communication unit transmits entrance information for informing a vehicle which enters a school zone of entering the school zone.

10. A method for informing of children-protection using an apparatus for informing of children-protection, which is installed in a school zone, comprising:
receiving, by a communication unit, user information transmitted from a user terminal;
detecting, by an informing control unit, terminal information corresponding to the user information received in receiving the user information from an informing information storing unit; and
transmitting, by the informing control unit, position information of the user terminal to a terminal corresponding to terminal information detected in detecting the terminal information.

11. The method for informing of children-protection according to claim 10, further comprising:
providing self-generated power supply, by a self-generation unit, to the communication unit, the informing information storing unit, and the informing control unit.

12. The method for informing of children-protection according to claim 10, wherein in the transmitting the position information of the user terminal, the informing control unit transmits position information of the school zone, which is stored in the informing information storing unit as the position information of the user terminal.

13. The method for informing of children-protection according to claim 10, wherein in receiving the user information, the communication unit receives environment information including at least one of an user image and a user sound from the user terminal in addition to the user information.

14. The method for informing of children-protection according to claim 13, wherein in transmitting the position information of the user terminal, the informing control unit transmits the environment information received in receiving the user information to the user terminal through the communication unit.

15. The method for informing of children-protection according to claim 10, wherein in transmitting the position information of the user terminal, the informing control unit periodically transmits at least one of the position information of the user terminal and the environment information received from the user terminal.

16. The method for informing of children-protection according to claim 10, wherein in transmitting the position information of the user terminal, the communication unit exchanges information with the user terminal through a wireless LAN SSID.

17. The method for informing of children-protection according to claim 10, wherein in transmitting the position information of the user terminal, the communication unit transmits entrance information for informing a vehicle which enters the school zone of entering the school zone.
